(19) United States
(12) Patent Application Publication
(10) Pub. No.: US 2026/0221782 A1
(43) Pub. Date: Jul. 30, 2026

(54) HOUSEHOLD ENERGY STORAGE SYSTEM IN AN OFF-GRID STATE AND BLACK START METHOD THEREFOR

(71) Applicant: FranklinWH Energy Technology Inc., SANTA CLARA, CA (US)

(72) Inventors: Junpeng YU, Shenzhen (CN); Song CHEN, Shenzhen (CN); Chi ZHANG, Shenzhen (CN)

(21) Appl. No.: 19/573,300

(22) Filed: Mar. 20, 2026

Related U.S. Application Data
(63) Continuation-in-part of application No. 18/096,890, filed on Jan. 13, 2023.
(60) Provisional application No. 63/341,454, filed on May 13, 2022.

(51) Int. Cl. H02J 3/388; H02J 3/007; H02J 3/32; H02J 7/00; H02J 7/35; H02J 7/82; H02J 101/24; H02J 105/12

(52) U.S. Cl. CPC H02J 3/388; H02J 3/007; H02J 3/32; H02J 7/35; H02J 7/82; H02J 7/865; H02J 2101/24; H02J 2105/12; H02J 2207/20

(57) ABSTRACT

A black start method for a household energy storage system in an off-grid state includes in response to detecting that a battery system is discharged to a state of charge (SOC) of less than or equal to a set value, sending a state of the battery system to an energy management system (EMS); sending timing starting time T1 and black start time T2 to a battery management system (BMS); starting timing from T1 and after time T, causing the household energy storage system to enter a sleep mode; in response to performing timing to T2, exiting the sleep mode and turning on an auxiliary power supply for power supply to the EMS; and in response to detecting that a startup condition is satisfied, turning on a bidirectional battery DC/DC converter and a PV DC/DC converter for charging the battery system using power from a PV system.

### CROSS-REFERENCE TO RELATED APPLICATION(S

This application is a continuation-in-part of application Ser. No. 18/096,890, filed Jan. 13, 2023, which claims priority to U.S. Provisional Application No. 63/341,454 filed with the United States Patent and Trademark Office (USPTO) on May 13, 2022, the content of all of which is incorporated herein by reference in their entirety.

### TECHNICAL FIELD

The present application relates to charging technology, for example, a household energy storage system in an off-grid state and a black start method therefor.

### BACKGROUND

With the development of new energy sources, an increasing number of photovoltaic generation systems (PV systems) have been introduced into households in recent years. Photovoltaic generation brings many benefits to people especially in areas with relatively good illumination. In the presence of sunlight in the daytime, the PV system can generate electrical energy to power household loads. However, in the absence of sunlight at night, the PV system cannot continue powering the household loads. Therefore, the PV system needs to be used on combination with a household energy storage system. In the presence of sufficient sunlight in the daytime, the household energy storage system divides, through a photovoltaic inverter, the electrical energy generated by the PV system into two parts, one part of which directly powers loads and the other part of which is stored in a battery system of the household energy storage system, so that the household energy storage system continues to power the loads at night through the battery system.

As electrical energy stored in the battery system is continuously consumed by one or more loads and the household energy storage system itself, power of the battery system is gradually decreased. When it is detected that the battery system is discharged to a state of charge (SOC) of less than or equal to a certain set value M, the household energy storage system enters a fully black model (also referred to as a sleep mode). When a certain condition is satisfied, a generator set (such as a power conversion system (PCS)) having a self-starting ability in the household energy storage system is started and then drives a generator set (such as an energy management system (EMS) and a battery management system (BMS)) having no self-starting ability to be started, achieving a black start of the household energy storage system.

In the case where the household energy storage system has no power grid connected, there is no scheme for achieving the black start of the household energy storage system.

### SUMMARY

Embodiments of the present application provide a household energy storage system in an off-grid state and a black start method therefor, so as to implement a black start of the household energy storage system in the off-grid state. The scheme can well solve the problem of the black start of the household energy storage system in the off-grid state especially under an extreme condition of a long-time power outage.

An embodiment of the present application provides a black start method for a household energy storage system in an off-grid state. The method includes the steps described below.

In response to detecting that a battery system is discharged to an SOC of less than or equal to a set value M, a BMS sends a state of the battery system to an EMS, where M is a number greater than 0 and less than 1.

The EMS sends timing starting time T1 and black start time T2 to the BMS.

The BMS starts timing from T1 and after a time T, instructs the battery system to stop working such that the household energy storage system enters a sleep mode.

In response to performing timing to T2, the BMS wakes an auxiliary power supply up for power supply to the EMS.

In response to detecting that the battery system is in a charging state, the EMS determines that a black start of the household energy storage system succeeds.

An embodiment of the present application provides a household energy storage system in an off-grid state. The system includes a BMS, an EMS, a PCS, and a battery system.

The BMS is configured to, in response to detecting that the battery system is discharged to an SOC of less than or equal to a set value M, send a state of the battery system to the EMS, where M is a number greater than 0 and less than 1.

The EMS is configured to receive the state of the battery system and send timing starting time T1 and black start time T2 to the BMS.

The BMS is further configured to, in response to performing timing for a time T from T1, instruct the battery system to stop working such that the household energy storage system enters a sleep mode, and in response to performing timing to T2, wake an auxiliary power supply up for power supply to the EMS.

The EMS is further configured to, in response to detecting that the battery system is in a charging state, determine that a black start of the household energy storage system succeeds.

In one aspect of the present disclosure, a black start method for a household energy storage system in an off-grid state includes in response to detecting that a battery system is discharged to an SOC of less than or equal to a set value M, sending a state of the battery system to an EMS by a BMS, wherein M is a number greater than 0 and less than 1; sending timing starting time T1 and black start time T2 to the BMS by the EMS; starting timing from T1 by the BMS and after time T, causing the household energy storage system to enter a sleep mode; in response to performing timing to T2, exiting the sleep mode and turning on an auxiliary power supply for power supply to the EMS by the BMS; and in response to detecting that a startup condition is satisfied, turning on a bidirectional battery DC/DC converter and a PV DC/DC converter respectively connected to the BMS and a PV system for charging the battery system using power from the PV system.

In another aspect of the present disclosure, a black start method for a household energy storage system in an off-grid state includes in response to detecting that a battery system is discharged to an SOC of less than or equal to a set value M, sending a state of the battery system to an EMS by a BMS, wherein M is a number greater than 0 and less than 1, and the BMS and the battery system are connected to a PCS, respectively; sending timing starting time T1 and black start time T2 to the BMS by the EMS; starting timing from T1 by the BMS and after time T, causing the household energy storage system to enter a sleep mode; in response to performing timing to T2, exiting the sleep mode and turning on an auxiliary power supply for power supply to the EMS by the BMS; and in response to detecting that a startup condition is satisfied, shutting off a first switch and a second switch to disconnect the PCS from a load and disconnect a PV system from the load, and closing a third switch to connect the PCS with the PV system.

In another aspect of the present disclosure, a black start method for a household energy storage system in an off-grid state includes in response to detecting that a battery system is discharged to an SOC of less than or equal to a set value M, sending a state of the battery system to an EMS by the BMS, wherein M is a number greater than 0 and less than 1, the BMS and the battery system are connected respectively to a PCS, and the PCS is connected to a PV system; sending timing starting time T1 and black start time T2 to the BMS by the EMS; starting timing from T1 by the BMS and after time T, causing the household energy storage system to enter a sleep mode; in response to performing timing to T2, exiting the sleep mode and turning on an auxiliary power supply by the BMS for power supply to the EMS; and in response to detecting that a startup condition is satisfied, shutting off a switch to disconnect the PCS from a load and disconnect the PV system from the load.

### BRIEF DESCRIPTION OF DRAWINGS

FIG. 1 is a structural diagram of a household energy storage system in an off-grid state according to an embodiment of the present application.

FIG. 2 is a structural diagram of another household energy storage system in an off-grid state according to an embodiment of the present application.

FIG. 3 is a structural diagram of another household energy storage system in an off-grid state according to an embodiment of the present application.

FIG. 4 is a structural diagram of another household energy storage system in an off-grid state according to an embodiment of the present application.

FIG. 5 is a structural diagram of another household energy storage system in an off-grid state according to an embodiment of the present application.

FIG. 6 is a structural diagram of another household energy storage system in an off-grid state according to an embodiment of the present application.

FIG. 7 is a flowchart of a black start method for another household energy storage system in an off-grid state according to an embodiment of the present application.

FIG. 8 is a flowchart of a black start method for another household energy storage system in an off-grid state according to an embodiment of the present application.

FIG. 9 is a flowchart of a black start method for another household energy storage system in an off-grid state according to an embodiment of the present application.

FIG. 10 is a flowchart of a black start method for another household energy storage system in an off-grid state according to an embodiment of the present application.

FIG. 11 is a flowchart of a black start method for another household energy storage system in an off-grid state according to an embodiment of the present application.

FIG. 12 is a flowchart of a black start method for another household energy storage system according to an embodiment of the present application.

FIG. 13 is a flowchart of a black start method for another household energy storage system in an off-grid state according to an embodiment of the present application.

FIG. 14 is a structural diagram of a household energy storage system according to an embodiment of the present application.

FIG. 15 is a flowchart of a black start method for a household energy storage system in an off-grid state according to an embodiment of the present application.

FIG. 16 is a partial structural diagram of a household energy storage system according to an embodiment of the present application.

FIG. 17 is a flowchart of a black start method for a household energy storage system in an off-grid state according to an embodiment of the present application.

FIG. 18 is a partial structural diagram of a household energy storage system according to an embodiment of the present application.

FIG. 19 is a flowchart of a black start method for a household energy storage system in an off-grid state according to an embodiment of the present application.

### DETAILED DESCRIPTION

The present application is described hereinafter in conjunction with drawings and embodiments. Only part, not all, of structures related to the present application are illustrated in the drawings. If not in collision, the embodiments described below and features therein may be combined with each other.

Additionally, terms such as "first" and "second" may be used for describing multiple directions, actions, steps, or elements in embodiments of the present application, but these directions, actions, steps, or elements are not limited by the terms. The terms are only used for distinguishing a first direction, action, step, or element from another direction, action, step, or element. For example, a first instruction may be referred to as a second instruction, or a second instruction may be referred to as a first instruction. The first instruction and the second instruction are both instructions, but the first instruction and the second instruction are instructions for performing different actions. The terms such as "first" and "second" cannot be construed as indicating or implying relative importance or implicitly indicating the number of technical features as indicated. Thus, a feature defined as a "first" feature or a "second" feature may explicitly or implicitly include one or more of such features. In embodiments of the present application, "multiple" means at least two, for example, two, three, or the like.

### Embodiment One

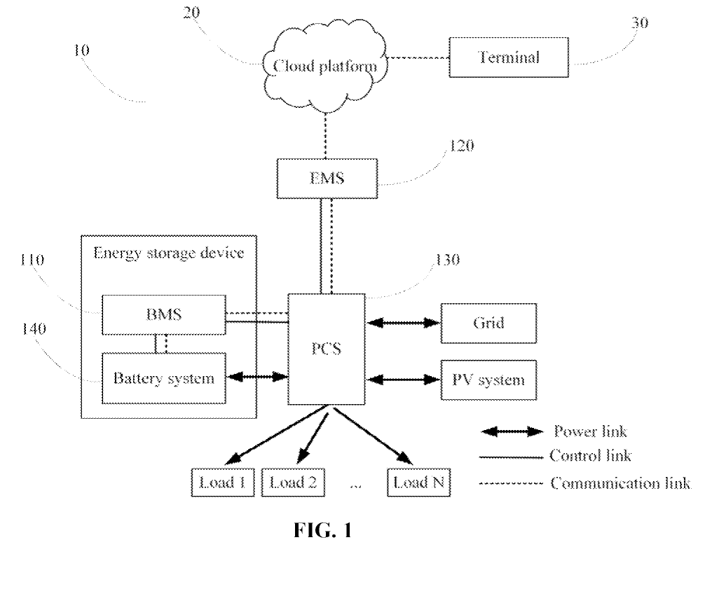

As shown in FIG. 1, an embodiment of the present application provides a household energy storage system 10 in an off-grid state, and the system 10 includes a BMS 110, an EMS 120, a PCS 130, and a battery system 140.

The BMS 110 is configured to manage charging and discharging operations of the battery system and perform signal acquisition.

The PCS 130 is configured to convert an alternating current voltage into a direct current voltage to charge the battery system, and when the battery system is discharged, convert a direct current voltage output by the battery system into an alternating current voltage connectable to a power grid and usable by a household such that a power supply parameter satisfies a predetermined requirement of the system. Additionally, the PCS also has the functions of power supply communication and information acquisition.

In some embodiments, the EMS 120 and the PCS 130 may be configured in an energy gateway. The energy gateway is configured with a communication unit and a switch unit, where the communication unit may implement communication with a cloud platform and the household energy storage system 10. In some embodiments, one household energy storage system may include one energy gateway and multiple energy storage devices.

When the household energy storage system includes only one energy storage device, considering that the PCS 130 generates relatively high heat in a working process, the PCS 130 is generally disposed in the energy gateway, so as to reduce the heat dissipation pressure of the household energy storage system. For example, in FIG. 1, the household energy storage system 10 includes one energy storage device, both the BMS 110 and the battery system 140 are disposed in the energy storage device, and the PCS 130 is disposed in the energy gateway (not shown in FIG. 1). Additionally, the household energy storage system may not include the switch unitof the energy gateway, and the PCS is directly connected to a PV system, a load, and the power grid, separately.

With continued reference to FIG. 1, when the household energy storage system has no power grid connected, the battery system powers one or more loads. For example, a switch is provided between the household energy storage system and the power grid, and the switch is turned off such that the household energy storage system has no power grid connected, which is referred to as the household energy storage system being in the off-grid state.

In FIG. 1, the BMS is configured to, in response to detecting that the battery system 140 is discharged to an SOC of less than or equal to a set value M, send a state of the battery system 140 to the EMS 120, where M is a number greater than 0 and less than 1.

The EMS 120 is configured to receive the state of the battery system 140 and send timing starting time T1 and black start time T2 to the BMS 110.

The BMS 110 is further configured to, in response to performing timing for a time T from T1, instruct the battery system 140 to stop working such that the household energy storage system 10 enters a sleep mode, and in response to performing timing to T2, wake an auxiliary power supply up for power supply to the EMS 120.

The EMS 120 is further configured to, in response to detecting that the battery system 140 is in a charging state, determine that a black start of the household energy storage system 10 succeeds.

As shown in FIG. 1, in an embodiment, the EMS 120 is connected to a cloud platform 20, where the cloud platform 20 is connected to a terminal 30.

The EMS 120 is configured to, before sending the timing starting time T1 and the black start time T2 to the BMS 110, send a turning-off instruction to the terminal 30 through the cloud platform 20 to instruct a user of the terminal 30 to turn off some or all loads in the household energy storage system 10.

In an embodiment, the EMS 120 is configured to, in response to detecting that the battery system 140 is in the charging state, determine that the black start of the household energy storage system 10 succeeds in the manner described below.

In response to determining that the household energy storage system 10 satisfies a first startup condition, the EMS 120 sends a startup instruction to the BMS 110 such that the BMS 110 instructs the battery system 140 to power the EMS 120, the BMS 110, and the PCS 130, so that the household energy storage system 10 exits from the sleep mode.

The EMS 120 sends a charging instruction to the PCS 130 such that the PCS 130 charges the battery system 140.

The EMS 120 receives a report from the BMS 110 that the battery system 140 is in the charging state, where the report is used for indicating that the BMS 110 detects, from a P-th minute to a Q-th minute after the PCS 130 charges the battery system, that the battery system is in the charging state.

The EMS 120 determines, according to the report, that the black start of the household energy storage system 10 succeeds.

That is to say, the EMS determines whether the system satisfies the first startup condition, and after it is determined that the system satisfies the first startup condition, the system exits from the sleep mode; the EMS then instructs the PCS to charge the battery system, and when it is detected that the battery system is always in the charging state within a predetermined time period (for example, from the P-th minute to the Q-th minute after the PCS 130 charges the battery system), the EMS determines that the black start of the system succeeds.

Exemplarily, after the system exits from the sleep mode, the EMS instructs a photovoltaic inverter in the PCS to convert a direct current generated by the PV system into an alternating current capable of charging the battery system.

It is to be understood that when the battery system is charged through electrical energy converted by the PCS, the load may be powered through the battery system or the electrical energy converted by the PCS.

To improve a success rate of the black start, it may be set that the load is not powered through the electrical energy converted by the PCS and that the battery system does not power the load when the battery system is charged through the electrical energy converted by the PCS.

In an embodiment, the EMS 120 determines that the household energy storage system 10 satisfies the first startup condition in the manner described below.

In response to determining that the household energy storage system 10 has no preset fault and determining that the SOC of the battery system 140 is greater than or equal to Q, the EMS 120 determines that the household energy storage system 10 satisfies the first startup condition, where Q is a number greater than or equal to 0 and less than or equal to M.

The preset fault includes one or more of a BMS fault, a PCS fault, or an EMS fault.

In an embodiment, in response to detecting that the battery system 140 is in the charging state, the EMS 120 determines that the black start of the household energy storage system 10 succeeds in the manner described below.

The EMS sends the charging instruction to the PCS to instruct the PCS to charge the battery system.

The EMS receives the report from the BMS that the battery system is in the charging state, where the report is used for indicating that the BMS detects, from the P-th minute to the Q-th minute after the PCS charges the battery system, that the battery system is in the charging state.

In response to determining that the household energy storage system satisfies a second startup condition, the EMS sends the startup instruction to the BMS such that the BMS instructs the battery system to power the EMS, the BMS, and the PCS, so that the household energy storage system exits from the sleep mode.

In response to detecting that the system exits from the sleep mode, the EMS determines that the black start of the household energy storage system succeeds.

That is to say, the EMS instructs the PCS to charge the battery system and determines whether the battery system is always in the charging state within the predetermined time period (for example, from the P-th minute to the Q-th minute after the PCS 130 charges the battery system); when determining that the battery system is always in the charging state within a predetermined time period, the EMS determines whether the system satisfies the second startup condition, and after it is determined that the system satisfies the second startup condition, the system exits from the sleep mode; and finally, the EMS determines that the black start of the system succeeds.

In this scheme, the EMS determines whether the system satisfies the second startup condition only when it is determined that the battery system is in the charging state and its SOC is greater than H (which indicates that the battery system stores relatively sufficient power and can ensure the normal operation of the system). If the system satisfies the second startup condition, the system exits from the sleep mode and the EMS determines that the black start of the system succeeds. After the black start of the system succeeds, the EMS may instruct the PCS to normally power the load.

In an embodiment, the EMS determines that the household energy storage system satisfies the second startup condition in the manner described below.

In response to determining that the household energy storage system has no preset fault and determining that the SOC of the battery system is greater than or equal to H, the EMS determines that the household energy storage system satisfies the second startup condition, where H is a number greater than or equal to M.

In an embodiment, the PCS charges the battery system according to the charging instruction in the manner described below.

The PCS turns on the photovoltaic inverter in the PCS according to the charging instruction to charge the battery system through electrical energy converted by the photovoltaic inverter.

The PV system converts solar energy into direct current electrical energy, and the photovoltaic inverter in the PCS converts the direct current electrical energy into stable alternating current electrical energy stored in the battery system.

In an embodiment, the BMS detects, from the P-th minute to the Q-th minute after the PCS charges the battery system, that the battery system is in the charging state in the manner described below.

The BMS detects whether a charging current flows through the battery system and in response to the charging current, determines that the battery system is in the charging state.

The battery system 140 may include at least one battery pack and at least one sensor. For example, the battery system 140 includes at least one of a temperature sensor, a humidity sensor, a voltage sensor, or a current sensor. The temperature sensor is used for detecting a working temperature of each battery pack, the humidity sensor is used for detecting a working environment of each battery pack, the voltage sensor is used for detecting a working voltage of each battery pack, and the current sensor is used for detecting a working current of each battery pack.

In the embodiment of the present application, the battery system includes the current sensor, and the BMS collects detection data of the current sensor and determines, according to the data, whether a charging current flows through the battery system.

In an embodiment, in the sleep mode, some control circuits in the BMS, the EMS, and the PCS are powered off.

Exemplarily, in the sleep mode, only a battery management unit (BMU) in the BMS in the system remains active, and all control circuits in the EMS and the PCS in the system are powered off.

In an embodiment, the auxiliary power supply is the battery system or another power supply connected to the household energy storage system and used for powering the EMS.

In an embodiment, the black start time T2 is a moment at which the PV system connected to the household energy storage system works.

After the system enters the sleep mode, some circuits in the EMS are powered off. The black start does not need to be performed in real time for the system, so as to prevent a large amount of electrical energy from being consumed. T2 is a certain moment predetermined by the system and at which the PV system normally works, for example, 10 am California time in the United States. When performing timing to the time T2, the BMS wakes the auxiliary power supply up for power supply to the EMS (wakes the EMS up), where the auxiliary power supply may be the battery system in the system. Considering that the battery system having relatively little power is not suitable for use as the auxiliary power supply, an external power supply connected to the system may be used as the auxiliary power supply, such as a car or a generator connected to the system.

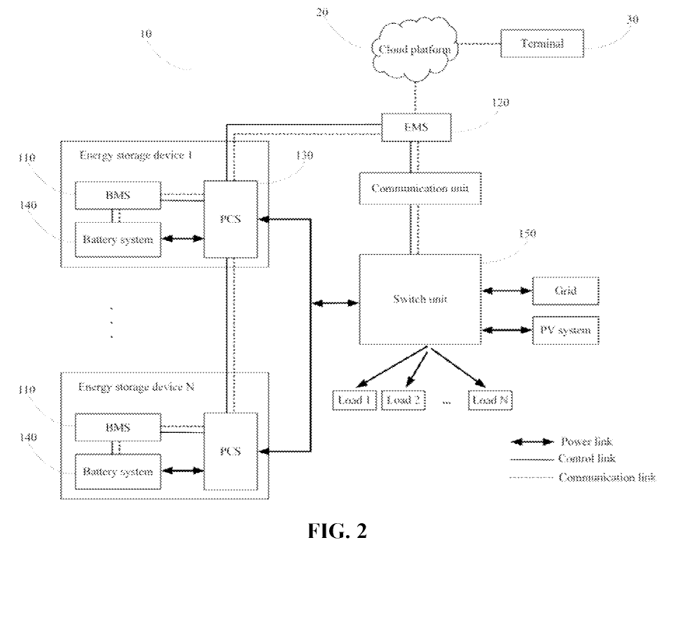

In FIG. 2 different from FIG. 1, the system includes multiple energy storage devices, where each energy storage device includes the BMS, the PCS, and the battery system.

In conjunction with the structure of the household energy storage system shown in FIG. 1, in FIG. 2, the system includes multiple energy storage devices, and each energy storage device includes one PCS. That is to say, when the system includes multiple energy storage devices, multiple PCSs are disposed in the multiple energy storage devices respectively instead of being disposed in the energy gateway. This arrangement can reduce the installation complexity of the energy gateway.

Additionally, in the system shown in FIG. 1, the PCS is directly connected to the PV system, the power grid, and multiple loads separately. In FIG. 2 different from FIG. 1, the system further includes a switch unit 150 of the energy gateway, where the PCS in each energy storage device is connected to the PV system, the power grid, and multiple loads separately through the switch unit 150.

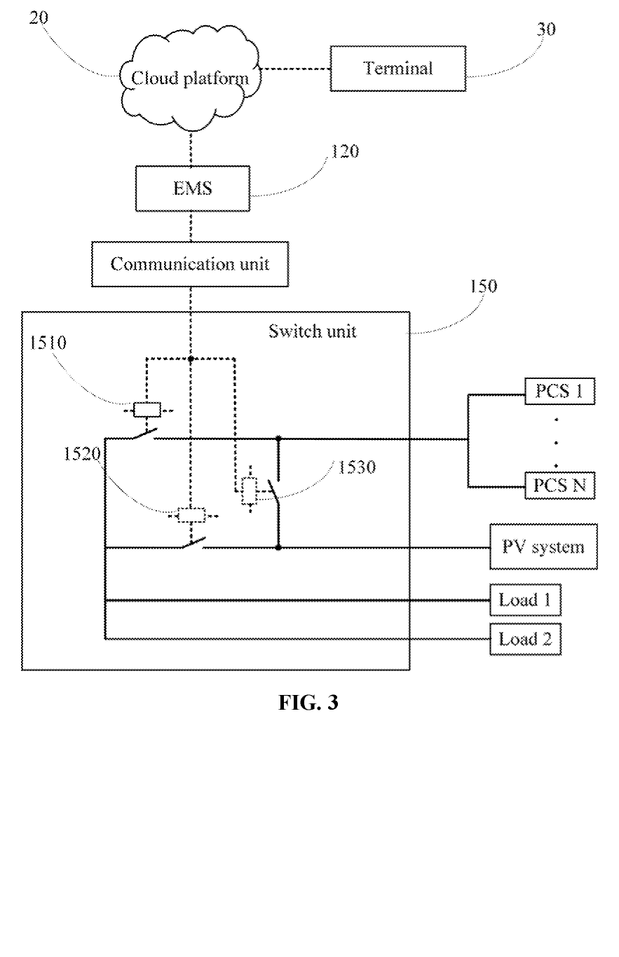

In contrast to FIG. 2, in FIGS. 3-5, the EMS 120 is connected to the terminal 30 through the cloud platform 20 and is also connected to the switch unit 150 through the communication unit.

In the embodiment of the present application, the household energy storage system 10 may include one or more loads which may include a lighting fixture, an air conditioner, a refrigerator, a television, a washing machine, and the like. The EMS 120 may send the turning-off instruction to the terminal 30 through the cloud platform 20 to instruct the user of the terminal 30 to turn off some or all loads in the household energy storage system 10 so that after the black start of the system succeeds (at this time, the battery system does not have sufficient power), as few loads as possible need to be charged by the battery system 140. For example, the user turns off the air conditioner, the refrigerator, the television, and the washing machine, leaving only the lighting fixture on. After the black start of the system succeeds, the EMS 120 instructs the PCS 130 to power the lighting fixture by using the battery system 140, so as to ensure the most basic power consumption requirement of the household energy storage system.

If the user has not turned off some or all loads in time after the terminal 30 receives the turning-off instruction, the EMS may autonomously turn off the some or all loads. To implement this scheme, the system includes the switch unit of the energy gateway, where the switch unit includes one or more switches. The EMS controls the switch to be turned off or on by sending an instruction to the switch unit so that the load is disconnected from or remains connected to the switch unit.

As shown in FIG. 3, the switch unit 150 includes a first switch 1510, a second switch 1520, and a third switch 1530.

The EMS 120 is configured to, before sending the timing starting time T1 and the black start time T2 to the BMS 110, send the turning-off instruction to the switch unit 150. The switch unit 150 is configured to turn off the first switch 1510 and the second switch 1520 and turn on the third switch 1530 according to the turning-off instruction to turn off all loads in the household energy storage system 10. Since the first switch and the second switch are turned off, neither the PV system nor the energy storage device can power the load, and the PV system can only transmit electrical energy to each PCS through the third switch turned on so that all electrical energy of the PV system is used for charging the battery system, improving the success rate of the black start.

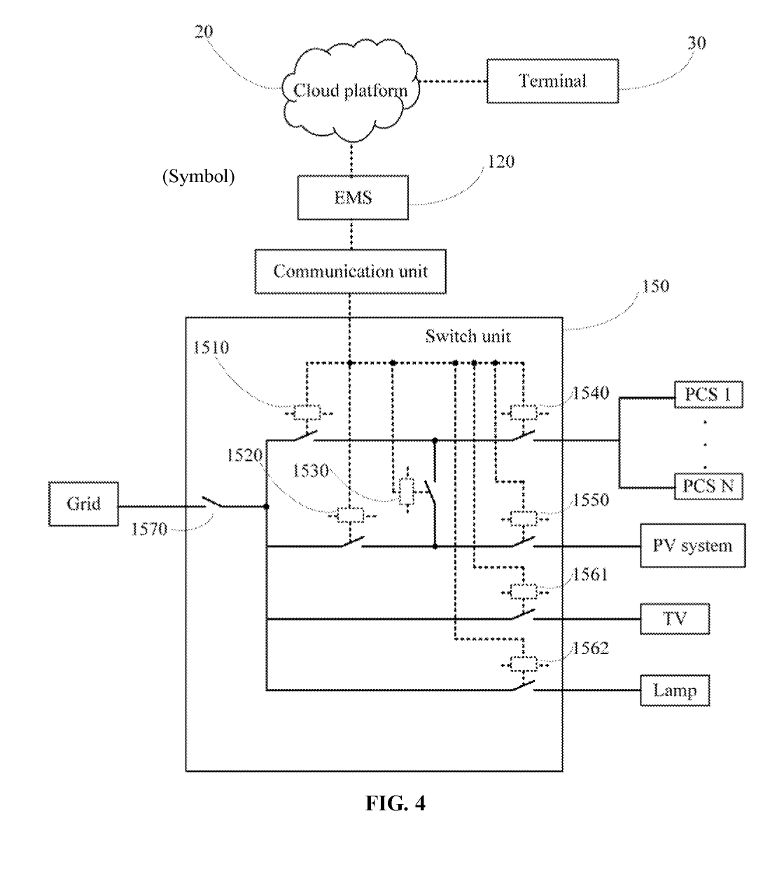

Additionally, on the basis of FIG. 3, as shown in FIG. 4, the switch unit further includes a branch switch disposed on each branch, for example, a PCS switch 1540 disposed on a PCS branch, a photovoltaic switch 1550 disposed on a branch between the PV system and the household energy storage system, and a load switch 1560 disposed on a load branch. Optionally, one load switch may be disposed on each load branch. For example, a load switch 1561 is disposed on a television branch, and a load switch 1562 is disposed on a lighting fixture branch.

The EMS may turn off the second switch 1520 and the load switch 1561 on the television branch and turn on the first switch 1510, the third switch 1530, the PCS switch 1540, the photovoltaic switch 1550, and the load switch 1562 on the lighting fixture branch through an instruction. Thus, neither the PV system nor the PCS can power the television, the PV system cannot power the lighting fixture, and the PCS can power the lighting fixture. The PV system can only transmit electrical energy to each PCS through the third switch turned on and the PCS powers the lighting fixture according to an instruction from the EMS so that all the electrical energy of the PV system is used for charging the battery system, ensuring the improvement of the success rate of the black start and the most basic power supply requirement of the household energy storage system.

It is to be understood that the EMS may also implement other charging and power supply schemes by adjusting the states of the preceding switches, and these similar schemes are no longer described here one by one.

Additionally, as shown in FIG. 4, the switch unit further includes a switch 1570 disposed on a power grid branch, and the switch is turned off such that the household energy storage system is disconnected from the power grid, so that the household energy storage system is in the off-grid state.

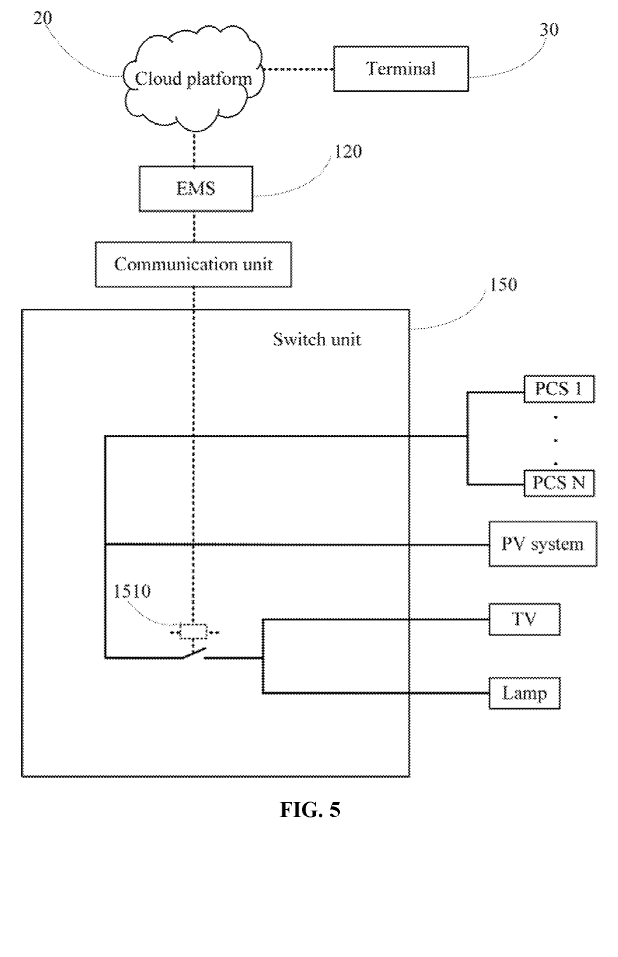

In contrast to the scheme in FIG. 3, in FIG. 5, the switch unit includes only the first switch 1510. The EMS 120 is configured to, before sending the timing starting time T1 and the black start time T2 to the BMS 110, send the turning-off instruction to the switch unit 150. The switch unit 150 is configured to turn off the first switch according to the turning-off instruction to turn off all loads in the household energy storage system.

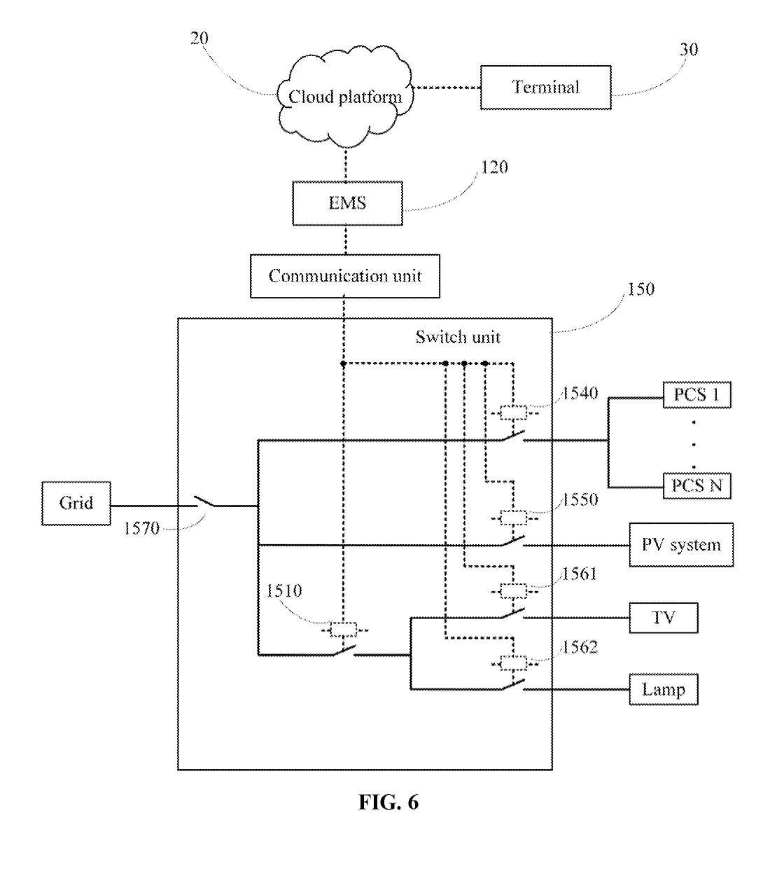

In contrast to the scheme in FIG. 4, in FIG. 6, the switch unit includes the first switch 1510, the PCS switch 1540, the photovoltaic switch 1550, the load switch 1561 disposed on the television branch, and the load switch 1562 disposed on the lighting fixture branch.

The EMS 120 is configured to, before sending the timing starting time T1 and the black start time T2 to the BMS 110, send the turning-off instruction to the switch unit 150. The switch unit 150 is configured to turn off the first switch according to the turning-off instruction to turn off all loads in the household energy storage system. Since the first switch 1510 is turned off, neither the PV system nor the energy storage device can power the load, and the PV system can only transmit electrical energy to each PCS through the PCS switch 1540 and the photovoltaic switch 1550 turned on so that all the electrical energy of the PV system is used for charging the battery system, improving the success rate of the black start.

Additionally, the switch unit may turn on the first switch 1510, the PCS switch 1540, the photovoltaic switch 1550, and the load switch 1562 disposed on the lighting fixture branch and turn off the load switch 1561 disposed on the television branch according to an instruction from the EMS to turn off some loads in the household energy storage system.

### Embodiment Two

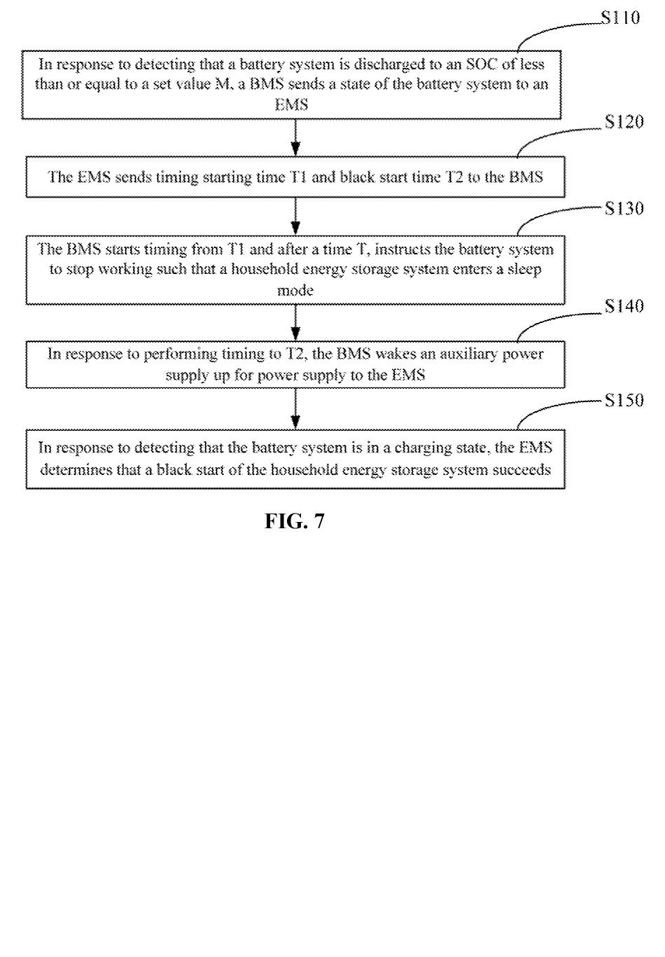

As shown in FIG. 7, an embodiment of the present application provides a black start method for a household energy storage system in an off-grid state, and the method includes steps S110 to S150.

In S110, in response to detecting that a battery system is discharged to an SOC of less than or equal to a set value M, a BMS sends a state of the battery system to an EMS, where M is a number greater than 0 and less than 1.

In S120, the EMS sends timing starting time T1 and black start time T2 to the BMS.

Exemplarily, at 23:30 California time in the United States, the BMS detects that the SOC of the battery system is 0.3 and less than the set value M = 0.35, and the BMS reports the state of the battery system to the EMS. The EMS determines the state of the battery system at 23:31 California time in the United States and sends the timing starting time T1 = 23:31 and the black start time T2 = 10:00 corresponding to T1 to the BMS.

Alternatively, at 23:30 California time in the United States, the BMS detects that the SOC of the battery system is 0.3 and less than the set value M = 0.35, and the BMS reports the state of the battery system to the EMS. The EMS sends the timing starting time T1 = 23:40 and the black start time T2 = 10:00 corresponding to T1 to the BMS.

That is to say, the timing starting time T1 may be time at which the EMS determines a state of a battery or may be time after the EMS determines a state of a battery. In the embodiment of the present application, an example in which T1 is the time at which the EMS determines the state of the battery is used.

In S130, the BMS starts timing from T1 and after a time T, instructs the battery system to stop working such that the household energy storage system enters a sleep mode.

The time T is a fixed waiting time set by the system. It is to be ensured within the time T that the PCS finishes being closed and the BMS cuts off the power supply to all circuit boards except a BMU. After the time T, the system smoothly enters the sleep mode. For example, T is a number greater than or equal to 1 min. In the embodiment of the present application, an example in which T = 5 min is used.

Exemplarily, the BMS receives the timing starting time T1 = 23:31 and the black start time T2 = 10:00 corresponding to T1 from the EMS, and starts the timing from the time T1. Within T = 5 min, the PCS is closed, the BMS cuts off the power supply to all the circuit boards except the BMU, and the battery system stops powering a load. At 23:36, the system enters the sleep mode.

In S140, in response to performing timing to T2, the BMU in the BMS wakes an auxiliary power supply up for power supply to the EMS.

Exemplarily, in the sleep mode, the battery system no longer powers the load in the system and powers only the BMU in the BMS.

When performing timing to 10:00 on a next day, the BMS wakes the auxiliary power supply up for the power supply to all control circuits in the EMS.

In S150, in response to detecting that the battery system is in a charging state, the EMS determines that a black start of the household energy storage system succeeds.

After working normally, the EMS determines that the black start of the system succeeds when it is detected that the battery system is in the charging state.

It is to be understood that the EMS determines that the black start of the system fails if it is not detected that the battery system is in the charging state, and the system enters the next black start subsequently.

The black start of the system may fail since a PV system fails to power the battery system due to a fault.

Exemplarily, the EMS determines at 10:20 California time in the United States that the black start of the system fails, and the BMS detects that the SOC of the battery system is 0.25 and less than the set value M = 0.35. The BMS reports the state of the battery system to the EMS. The EMS determines at 10:21 that the black start of the system fails and sends the timing starting time T1 = 10:21 and the black start time T2 = 11:00 corresponding to T1 to the BMS.

The BMS receives the timing starting time T1 = 10:21 and the black start time T2 = 11:00 corresponding to T1 from the EMS, and starts timing from the time T1. After T = 5 min (that is, at 10:26), the system enters the sleep mode.

When performing timing to 11:00, the BMS wakes the auxiliary power supply up for the power supply to all the control circuits in the EMS. The EMS determines whether the battery system is in the charging state and determines that the black start of the system succeeds if the battery system is in the charging state. Otherwise, the system enters the next black start subsequently.

It is to be understood that the system may include multiple groups of T1, T2, and T so that it is convenient for the system to enter the black start multiple times.

Exemplarily, T may be determined according to a time required for the PCS to be closed and a time required for the BMS to cut off the power supply to all the circuit boards except the BMU. Additionally, within the time T, the EMS may also send an indication to a terminal through a cloud platform to remind a user that the system enters the sleep mode after the time T and to request the user to turn off some or all loads in the system. Thus, T may also be set according to the number of loads in the system. In response to a smaller number of loads in the system, T may be set to be shorter, for example, 5 min. In response to a larger number of loads in the system, T may be set to be longer, for example, 10 min.

Exemplarily, T2 may be set to be a moment at which the PV system works.

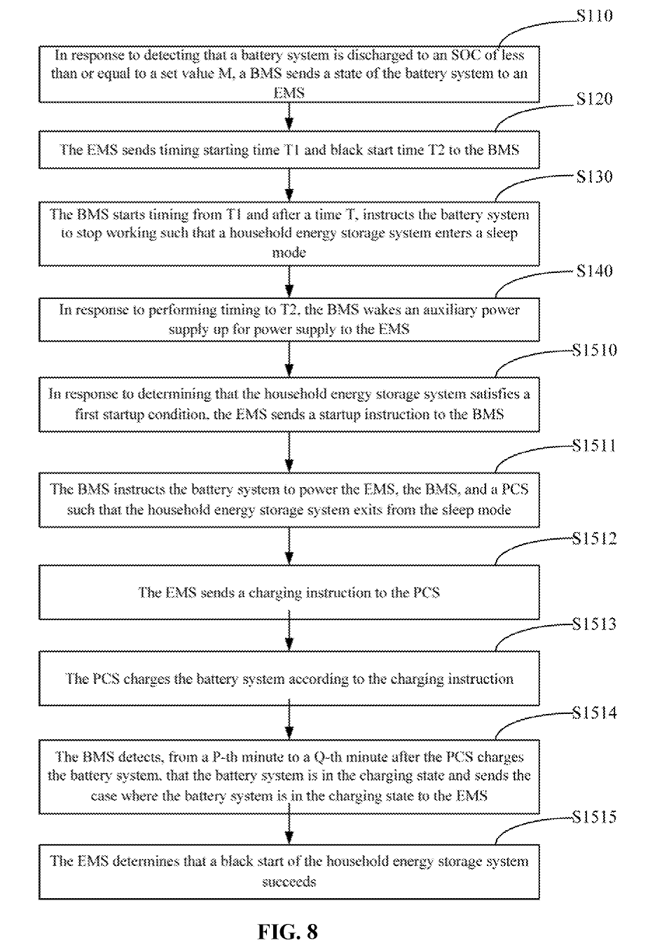

As shown in FIG. 8, in an embodiment, in S150, in response to detecting that the battery system is in the charging state, the EMS determines that the black start of the household energy storage system succeeds through the steps described below.

In S1510, in response to determining that the household energy storage system satisfies a first startup condition, the EMS sends a startup instruction to the BMS.

In S1511, the BMS instructs, according to the startup instruction, the battery system to power the EMS, the BMS, and a PCS such that the household energy storage system exits from the sleep mode.

In S1512, the EMS sends a charging instruction to the PCS.

In S1513, the PCS charges the battery system according to the charging instruction.

In S1514, the BMS detects, from a P-th minute to a Q-th minute after the PCS charges the battery system, that the battery system is in the charging state and sends the case where the battery system is in the charging state to the EMS.

In S1515, the EMS determines that the black start of the household energy storage system succeeds.

Exemplarily, the BMS determines that the battery system starts being charged from 10:10 and determines, from a fifth minute to a 20th minute after the battery system is charged (that is, from 10:15 to 10: 30), that the battery system is always in the charging state. The BMS reports the charging state of the battery system to the EMS, and the EMS determines that the black start of the system succeeds.

That is to say, the EMS determines whether the system satisfies the first startup condition, and after it is determined that the system satisfies the first startup condition, the system exits from the sleep mode; the EMS then instructs the PCS to charge the battery system, and when determining that the battery system is always in the charging state within a predetermined time period (for example, from the P-th minute to the Q-th minute after the PCS 130 charges the battery system), the EMS determines that the black start of the system succeeds.

In this scheme, after the system exits from the sleep mode, the EMS instructs a photovoltaic inverter in the PCS to convert a direct current generated by the PV system into an alternating current capable of charging the battery system.

In an embodiment, in S1510, the EMS determines that the household energy storage system satisfies the first startup condition in the following manner: in response to determining that the household energy storage system has no preset fault and determining that the SOC of the battery system is greater than or equal to Q, the EMS determines that the household energy storage system satisfies the first startup condition, where Q is a number greater than or equal to 0 and less than or equal to M.

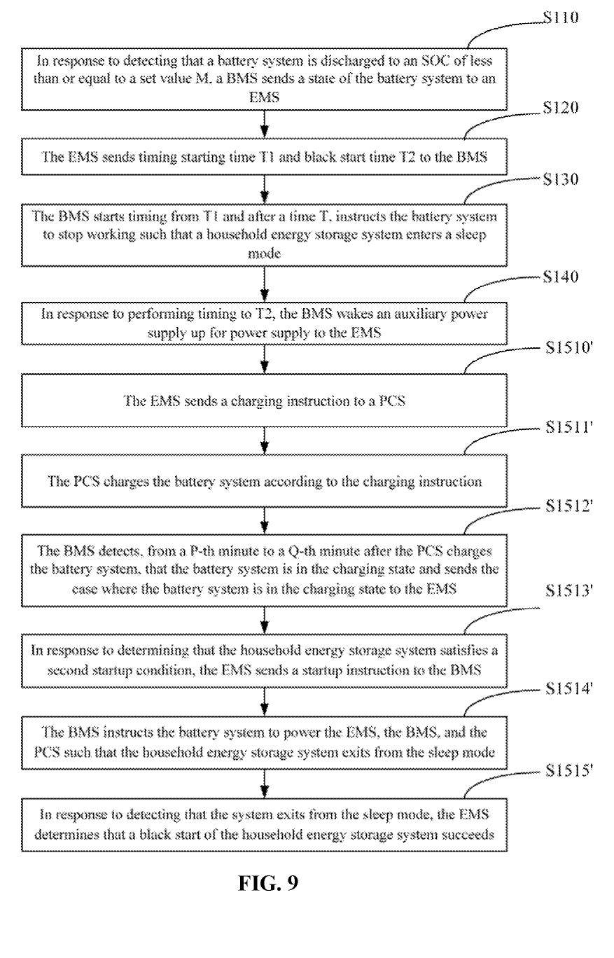

As shown in FIG. 9, in an embodiment, in S150, in response to detecting that the battery system is in the charging state, the EMS determines that the black start of the household energy storage system succeeds through the steps described below.

In S1510', the EMS sends a charging instruction to the PCS.

In S1511', the PCS charges the battery system according to the charging instruction.

In S1512', the BMS detects, from a P-th minute to a Q-th minute after the PCS charges the battery system, that the battery system is in the charging state and sends the case where the battery system is in the charging state to the EMS.

In S1513', in response to determining that the household energy storage system satisfies a second startup condition, the EMS sends a startup instruction to the BMS.

In S1514', the BMS instructs, according to the startup instruction, the battery system to power the EMS, the BMS, and the PCS such that the household energy storage system exits from the sleep mode.

In S1515', in response to detecting that the system exits from the sleep mode, the EMS determines that the black start of the household energy storage system succeeds.

That is to say, the EMS instructs the PCS to charge the battery system and determines whether the battery system is always in the charging state within the predetermined time period (for example, from the P-th minute to the Q-th minute after the PCS 130 charges the battery system); when determining that the battery system is always in the charging state within a predetermined time period, the EMS determines whether the system satisfies the second startup condition, and after it is determined that the system satisfies the second startup condition, the system exits from the sleep mode; and finally, the EMS determines that the black start of the system succeeds.

In this scheme, the EMS determines whether the system satisfies the second startup condition only when it is determined that the battery system is in the charging state and its SOC is greater than H (which indicates that the battery system stores relatively sufficient power and can ensure the normal operation of the system). If the system satisfies the second startup condition, the system exits from the sleep mode and the EMS determines that the black start of the system succeeds. The EMS instructs the PCS to supply electrical energy to loads in the system.

In an embodiment, in S1513', the EMS determines that the household energy storage system satisfies the second startup condition in the following manner: in response to determining that the household energy storage system has no preset fault and determining that the SOC of the battery system is greater than or equal to H, the EMS determines that the household energy storage system satisfies the second startup condition, where H is a number greater than or equal to M.

In an embodiment, S1513 or S1511' in which the PCS charges the battery system according to the charging instruction includes that the PCS turns on the photovoltaic inverter in the PCS according to the charging instruction to charge the battery system through electrical energy converted by the photovoltaic inverter.

In an embodiment, in S1514 or S1512', that the BMS detects, from the P-th minute to the Q-th minute after the PCS charges the battery system, that the battery system is in the charging state includes that the BMS detects whether a charging current flows through the battery system and in response to the charging current, determines that the battery system is in the charging state.

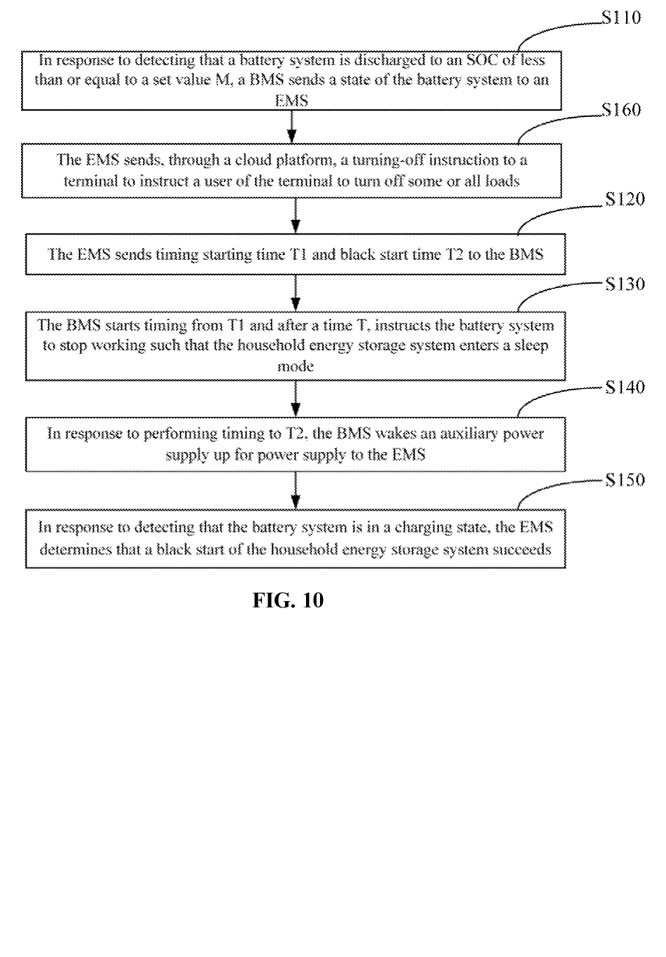

As shown in FIG. 10, in an embodiment, before S120 in which the EMS sends the timing starting time T1 and the black start time T2 to the BMS, the method further includes S160.

In S160, the EMS sends, through the cloud platform, a turning-off instruction to the terminal bound to the cloud platform to instruct the user of the terminal to turn off some or all loads in the household energy storage system.

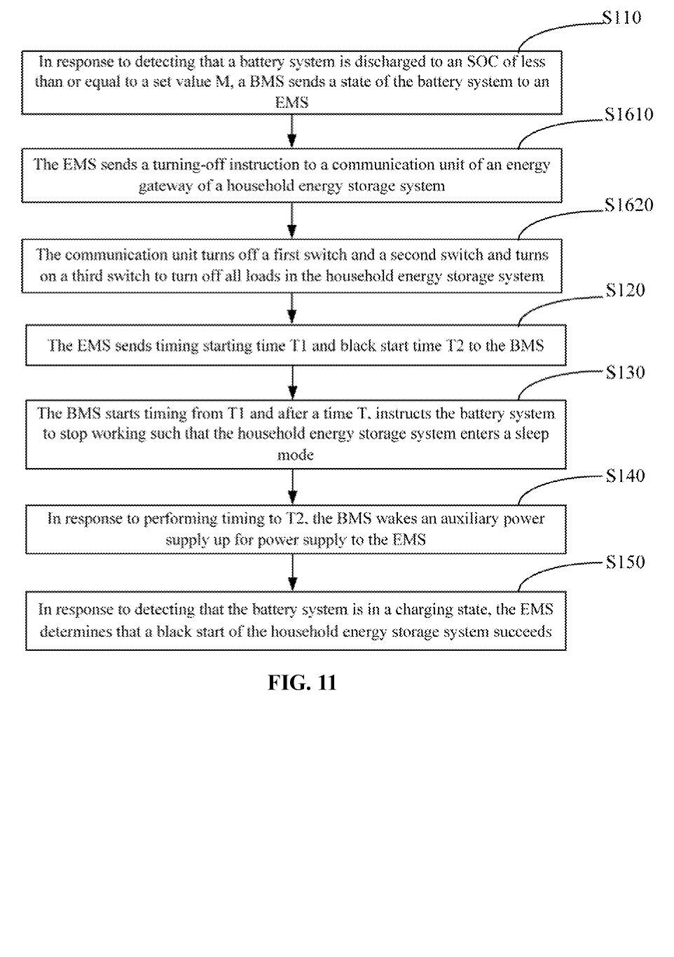

As shown in FIG. 11, in an embodiment, before S120 in which the EMS sends the timing starting time T1 and the black start time T2 to the BMS, the method further includes S1610 and S1620.

In S1610, the EMS sends a turning-off instruction to a switch unit of an energy gateway of the household energy storage system.

In S1620, the switch unit turns off a first switch and a second switch of the switch unit and turns on the third switch of the switch unit according to the turning-off instruction to turn off all loads in the household energy storage system.

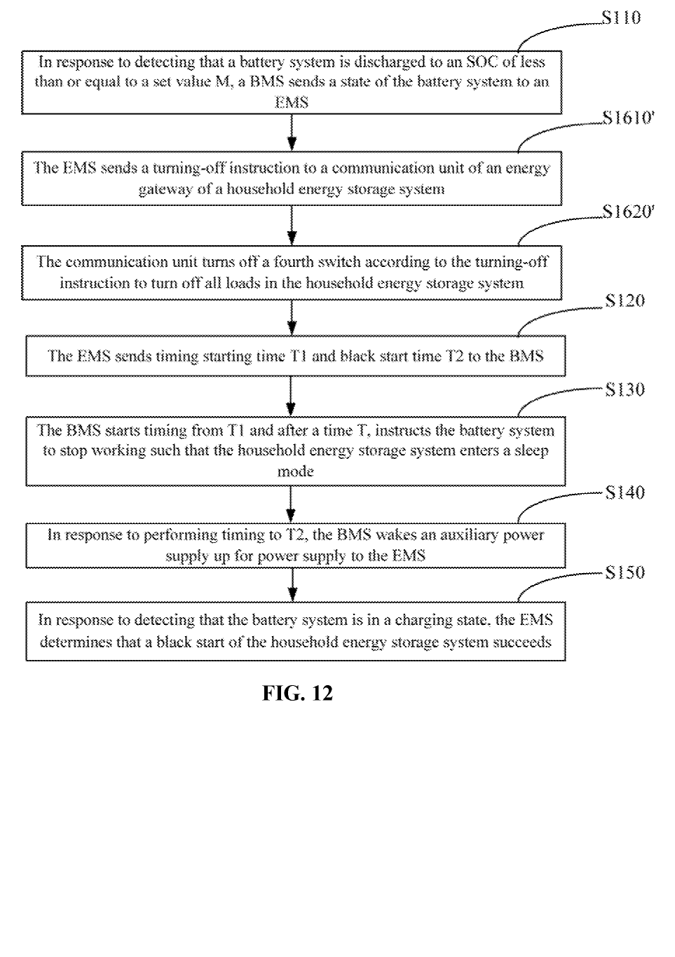

As shown in FIG. 12, in an embodiment, before S120 in which the EMS sends the timing starting time T1 and the black start time T2 to the BMS, the method further includes S1610' and S1620'.

In S1610', the EMS sends a turning-off instruction to a switch unit of an energy gateway of the household energy storage system.

In S1620', the switch unit turns off a first switch of the switch unit according to the turning-off instruction to turn off all loads in the household energy storage system.

In an embodiment, the auxiliary power supply is the battery system or another power supply connected to the household energy storage system and used for powering the EMS.

In an embodiment, the black start time T2 is a moment at which the PV system connected to the household energy storage system works.

Since the PV system can only work in the presence of sunlight in the daytime, to reduce the number of black starts of the system and improve the success rate of the black start, the black start time T2 is set to be a moment at which the PV system works, for example, a certain moment between 10:00 and 15:00 California time in the United States.

### Embodiment Three

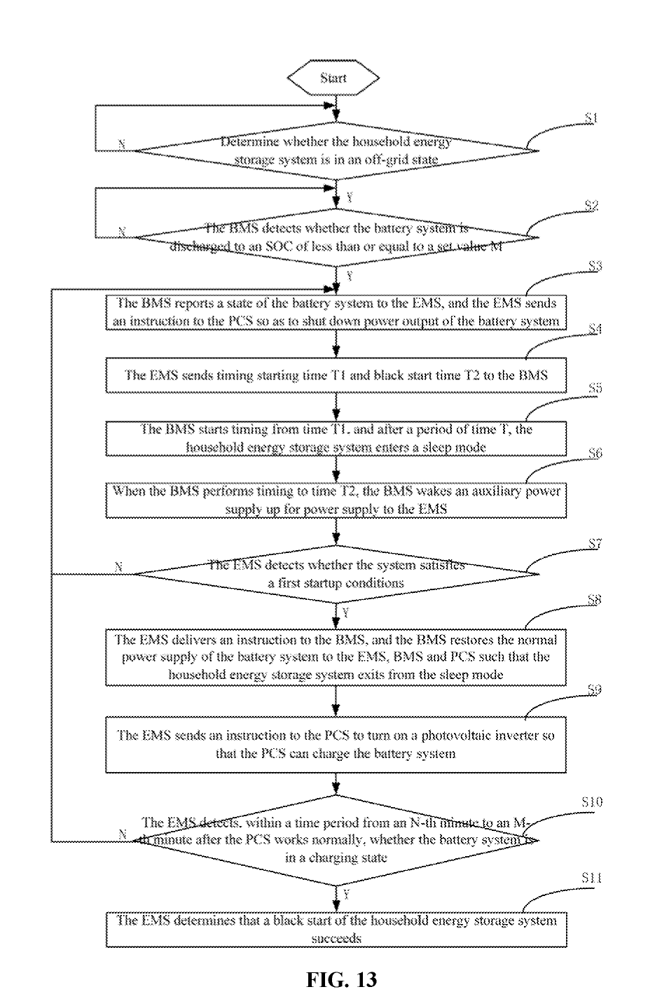

FIG. 13 is a schematic flowchart of a black start method for a household energy storage system. The black start method includes steps S1 to S11.

In step S1, it is determined whether the household energy storage system is in an off-grid state. If the household energy storage system is in the off-grid state, step S2 is performed. Otherwise, step S1 is performed repeatedly.

In step S2, a BMS detects whether a battery system is discharged to an SOC of less than or equal to a set value M. If the SOC is less than or equal to the set value M, step S3 is performed. Otherwise, step S2 is performed repeatedly.

In step S3, the BMS reports a state of the battery system to an EMS, and the EMS sends an instruction to a PCS so as to shut down power output of the battery system.

The PCS shuts down the power output of the battery system according to the instruction sent by the EMS. At this time, the battery system stops powering a load in the system. It is to be understood that the battery system still keeps powering control devices such as the EMS, BMS, and PCS in the system.

Exemplarily, the EMS notifies a cloud platform that the household energy storage system is about to enter a sleep mode, and the cloud platform sends information to a terminal bound to the household energy storage system by a user to prompt the user that the household energy storage system is about to enter the sleep mode and will be restarted at specified time and to request the user to turn off some or all loads so that when restarted, the household energy storage system has a relatively small number of loads and relatively low power consumption.

In addition to requesting the user to turn off some or all loads, the EMS may autonomously turn off some or all loads in the system. For example, a switch unit of an energy gateway is disposed in the system, the switch unit includes one or more switches, each load is connected to the EMS through a corresponding switch, and the EMS controls, through an instruction, a switch to be turned off to turn off a load.

In step S4, the EMS sends time information to the BMS, where the time information includes timing starting time T1 and black start time T2.

In step S5, when the BMS receives the time information, the BMS starts timing from time T1, and after a time T, the household energy storage system enters the sleep mode.

Exemplarily, in the sleep mode, only a BMU in the BMS is powered in the household energy storage system.

In step S6, when the BMS performs timing to the black start time T2, the BMS wakes an auxiliary power supply up such that the auxiliary power supply powers the EMS through the PCS.

In step S7, the EMS detects whether the household energy storage system satisfies a first startup condition. If the first startup condition is satisfied, step S8 is performed. Otherwise, step S3 is performed.

Exemplarily, the EMS determines whether the household energy storage system has a serious fault and determines whether the battery system satisfies that SOC ≥ Q, where 0 ≤ Q ≤ M. When it is determined that the household energy storage system has no serious fault and that the battery system satisfies that SOC ≥ Q, where 0 ≤ Q ≤ M, it is determined that the household energy storage system satisfies the startup condition.

In step S8, the EMS delivers an instruction to the BMS, and the BMS restores the normal power supply of the battery system to the EMS, BMS, and PCS according to the instruction such that the household energy storage system exits from the sleep mode.

In step S9, the EMS sends an instruction to the PCS to turn on a photovoltaic inverter in the PCS so that the PCS can charge the battery system by power generated by a PV system.

In step S10, the BMS detects, within a time period from an N-th minute to an M-th minute after the photovoltaic inverter in the PCS is turned on, whether the battery system is in a charging state. If the battery system is in the charging state, step S11 is performed. Otherwise, it is determined that a black start of the household energy storage system fails, and the process returns to step S3.

Exemplarily, it is determined whether the PV system is charging the battery system. For example, the BMS detects whether a charging current exists. If the charging current is detected, the battery system is in the charging state, and the BMS reports the information to the EMS.

Exemplarily, when determining that the black start of the household energy storage system fails, the EMS pushes a message that "the black start fails" to the terminal bound to the user through the cloud platform. Subsequently, the household energy storage system enters the next black start.

In step S11, the EMS determines that the black start of the household energy storage system succeeds.

The scheme can automatically implement the black start of the household energy storage system in the case where the household energy storage system is in the off-grid state. Particularly, the scheme can well solve the problem of startup of a photovoltaic energy storage system for household power supply, for example, under an extreme condition of a long-time power outage.

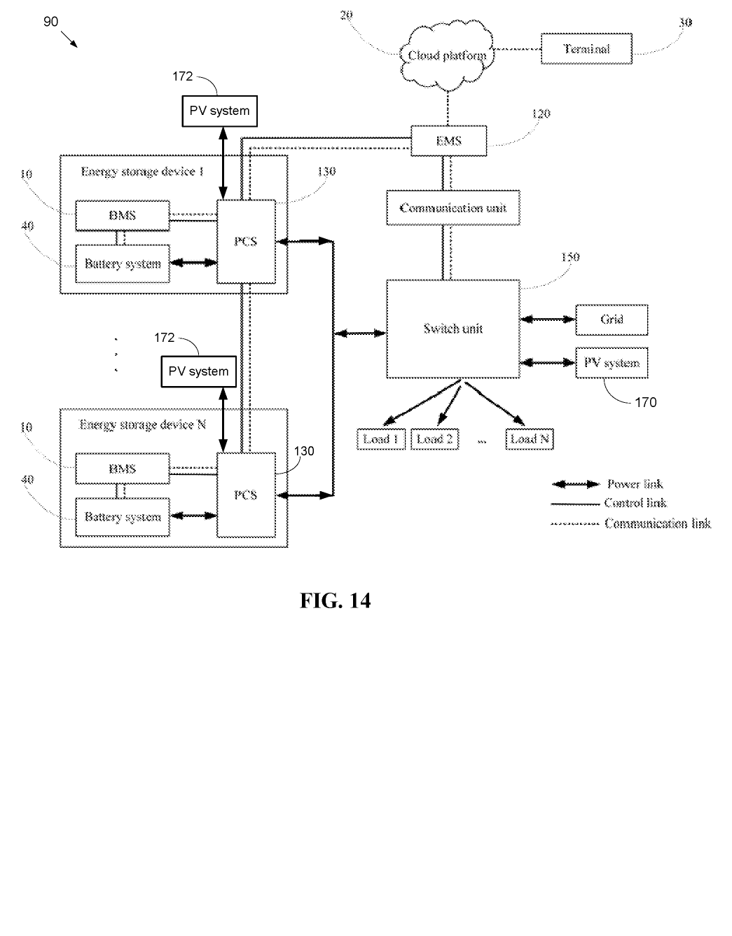

FIG. 14 illustrates a structural diagram of a household energy storage system 90 according to embodiments of the present application. In some embodiments, the household energy storage system 90 may contain devices and components included in the household energy storage system 10 as described above and shown in FIG. 2. The household energy storage system 90 may use the above-described methods of the household energy storage system 10.

In some embodiments, the household energy storage system 90 includes an EMS 120, a switch unit 150, and multiple energy storage devices. Each energy storage device includes a BMS 110, a PCS 130, and a battery system 140. The PCS in each energy storage device is connected to a PV system 172 directly and connected to a PV system 170, a power grid, and multiple loads separately through the switch unit 150. Compared to the household energy storage system 10, the household energy storage system 90 additionally contains the PV systems 172.

As described above, the BMS 110 is configured to manage charging and discharging operations of the battery system 140 and perform signal acquisition. The PCS 130 is configured to convert an alternating current voltage into a direct current voltage to charge the battery system 140. When the battery system 140 is discharged, the PCS 130 converts a direct current voltage output by the battery system 140 into an alternating current voltage connectable to the power grid and usable by a household. The power supply parameters satisfy predetermined requirements of the household energy storage system 90. Further, the PCS is configured to receive a direct current from the PV system 172, charge the battery system 140, or transmit electrical energy to an AC port. Additionally, the PCS also has functions of power supply communication and information acquisition.

Optionally, the PCS 130 contains three parts. A first part is a bidirectional battery DC/DC converter used for conversion between the battery system 140 and a DC bus. A second part is a PV DC/DC converter used for conversion between PV strings/PV arrays and the DC bus. A third part is a bidirectional DC/AC inverter for inversion between DC power and AC power.

The battery system 140 may include battery packs and sensors for sensing a state of the battery packs. For example, the sensors may include at least one of a temperature sensor, a humidity sensor, a voltage sensor, or a current sensor.

Optionally, the EMS 120 and the PCS 130 may be configured in an energy gateway. The energy gateway is configured with a communication unit and the switch unit 150. The communication unit may implement communication with the cloud platform 20 and the household energy storage system 90. The BMS 110 and the battery system 140 together form the energy storage device. In some embodiments, a user may decide to install one energy gateway and multiple energy storage devices at the household energy storage system 90.

Referring to FIG. 14, when the household energy storage system 90 has no power grid connected, the battery systems 140 power the loads. When there is sunlight, the PV systems 170 and 172 charge the battery systems 140. In the absence of sunlight, the household energy storage system 90 may still power the loads. As the electrical energy stored in the battery systems 140 is continuously consumed by the loads and the household energy storage system 90, power of the battery systems 140 is gradually decreased. When the BMSs detect that the battery systems 140 are discharged to an SOC of less than or equal to a certain set value n, the BMSs 110 report the state of the battery systems 140 to the EMS 120. Optionally, n is a number larger than zero and smaller than 1. The EMS 120 sends instructions to the PCSs 130 to shut down power output of the battery systems 140. Further, the EMS 120 sends timing starting time N and black start time M to the BMSs 110. Optionally, the black start time M may be a time during the daytime, such as during a working period of the PV systems 170 and 172. After receiving the timing starting time N and the black start time M, the BMSs 110 start performing timing. The household energy storage system 90 enters a sleep mode with low power consumption. The power to some control circuits of the EMS 120, BMSs 110, and PCSs 130 are turned off, making the power consumption of the household energy storage system 90 very low.

When performing timing to the black start time M, the household energy storage system 90 exits the sleep mode. The BMSs 110 wake up an auxiliary power supply to power the EMS 120. The auxiliary power supply may be a battery system in the household energy storage system 90. The auxiliary power supply may also be other power supply connected to the system 90, such as a car or a generator that may power the EMS 120.

After being powered by the auxiliary power supply, the EMS 120 checks whether the household energy storage system 90 satisfies a startup condition. When it is detected the startup condition is satisfied, the EMS 120 sends instructions to turn on the bidirectional battery DC/DC converters and the PV DC/DC converters at the PCSs 130 for charging the battery systems 140 using DC power from the PV systems (e.g., PV systems 172).

Further, the EMS 120 determines whether the battery systems 140 are in a charging state. For example, the EMS 120 may detect whether the PV systems 172 are charging the battery systems 140, and the BMSs 110 may detect whether there is any charging current. Detection of charging currents may indicate the battery systems 140 are in a charging state. After it is determined the battery systems 140 are in the charging state, the EMS 120 determines that the black start of the household energy storage system 90 succeeds and is completed.

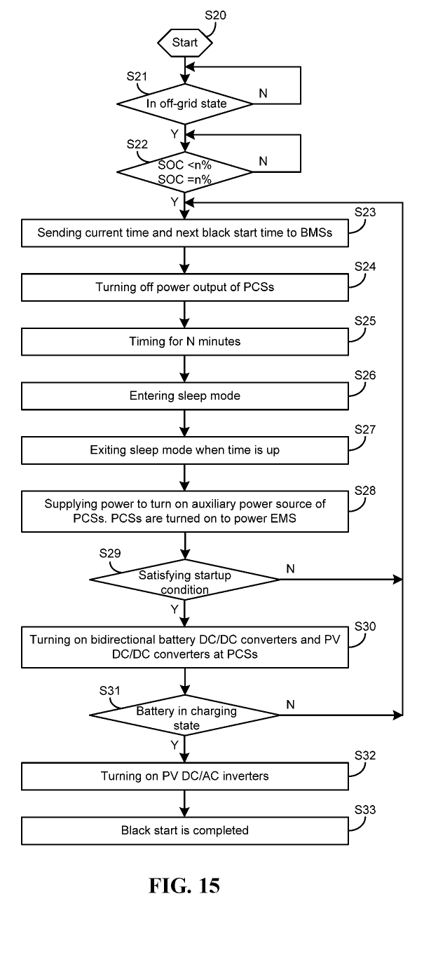

FIG. 15 illustrates a flowchart of a black start method for the household energy storage system 90 in an off-grid state according to embodiments of the present application. The household energy storage system 90 contains one or more energy storage devices. The method starts in step S20. In step S21, after it is detected that the household energy storage system 90 is in an off-grid state, the next step is performed.

In step S22, the household energy storage system 90 detects and determines whether the SOC of all energy storage devices is smaller than or equal to a set value n through the BMSs 110. If the answer is no, step S22 is taken again and the SOC of all energy storage devices is monitored continuously by the BMSs 110. If the answer is yes, i.e., the SOC of all energy storage devices is smaller than or equal to the set value n, the BMSs 110 send a state of the battery systems 140 to the EMS 120 and the next step is performed.

In step S23, the EMS 120 at the household energy storage system 90 sends the current time T1a and next black start time T2a to the BMSs 110.

In step S24, the power output of all PCSs is turned off by the EMS 120. Further, the power output of all energy storage devices are shut down.

In step S25, the BMSs 110 start performing timing for N minutes after receiving the next black start time.

In step S26, after a preset period of time (e.g., starting from time T1a), the main detection and control circuits of the household energy storage system 90 are powered off, e.g., by the BMSs 110. The battery systems 140 stop working in step S24 or step S26. The household energy storage system 90 enters the sleep mode.

In step S27, timing is performed at low-power timing control components at the household energy storage system 90. When the time is up, e.g., after performing timing to time T2a, the BMSs 110 or a power supply control system at the household energy storage system 90 is waked up automatically. The household energy storage system 90 exits the sleep mode.

In step S28, power is supplied to an auxiliary power source of the PCSs 130, e.g., by the BMSs 110. The auxiliary power source is turned on to power the PCSs 130. Further, the PCSs 130 are turned on to power the EMS 120.

In step S29, the household energy storage system 90 (or the EMS 120) determines whether a startup condition is satisfied. Exemplary startup conditions may include the household energy storage system 90 has no major failure and the SOC of the battery systems 140 is greater than or equal to a preset value H. If the startup conditions are not satisfied, it goes back to step S23. If the startup conditions are satisfied, it proceeds to the next step.

In step S30, in response to that the startup conditions are met, the household energy storage system 90 generates instructions to turn on the bidirectional battery DC/DC converters and the PV DC/DC converters at the PCSs 130. The bidirectional battery DC/DC converters and the PV DC/DC converters are used to charge the battery systems 140 using DC power from the PV systems 172. The PV DC/AC inverters at the PCSs 130 remain in an off state.

In step S31, timing is performed after the bidirectional battery DC/DC converters and the PV DC/DC converters are turned on. During a time period, e.g., between the N-th minute and the M-th minute, it is detected whether the battery systems 140 are in a charging state. If the battery systems 140 are not in a charging state, it goes back to step S23. If the battery systems 140 are in a charging state at a time in the time period, it proceeds to the next step.

In step S32, the household energy storage system 90 (or the EMS 120) turns on the bidirectional DC/AC inverters at the PCSs 130 for charging the battery systems 140. Optionally, before step S32, the loads are disconnected from the PCSs 130 and maintain a power off state. In some cases, before step S33, the loads are disconnected from the PCSs 130 and maintain a power off state.

In step S33, in response to that the battery systems 140 are in the charging state, the EMS 120 determines the black start of the household energy storage system 90 succeeds and is completed.

If the battery systems 140 are not in the charging state in step S31, the EMS 120 determines the black start fails. The household energy storage system 90 sends a black start failure message to a user and redoes steps from S23 to S31.

The above method containing steps from S20 to S33 is configured to achieve a black start of the household energy storage system 90 in an off-grid state, especially in certain extreme conditions of prolonged power outage. The method may solve startup problems of household energy storage systems. In addition, the black start method utilizes the DC power from the PV systems for charging the battery systems 140, which is not affected by AC loads. Compared to using AC power from the PV systems for charging the battery systems 140, a higher success rate of black start may be achieved.

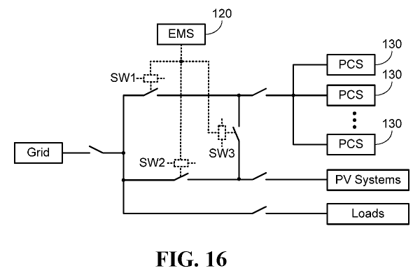

FIG. 16 illustrates a partial structural diagram of the household energy storage system 90 according to embodiments of the present application. The household energy storage system 90 has a configuration as shown in FIG. 14. Optionally, as shown in FIG. 16, the household energy storage system 90 may further include switches SW1, SW2, and SW3. These switches are arranged for connections among the PCSs 130, the PV systems, and loads. Optionally, first ends of the switches SW1 and SW2 are connected together and connected to the loads. A second end of the switch SW1 and a first end of the switch SW3 are connected together and connected to the PCSs. Second ends of the switches SW2 and SW3 are connected together and connected to the PV systems. As such, the switch SW1 connects the PCSs with the loads, the switch SW2 connects the PV systems with the loads, and the switch SW3 connects the PCSs with the PV systems. The terms “connection” and “connect”, as used herein with the switches, indicate electrical connection and electrically connecting, respectively. In some embodiments, the switches SW1, SW2, and SW3 are part of the switch unit 150 shown in FIG. 14. In some other embodiments, the switches SW1, SW2, and SW3 are not part of the switch unit 150 shown in FIG. 14.

As illustrated above, the household energy storage system 90 in an off-grid state may enter a sleep mode. When the time is up, the household energy storage system 90 exits the sleep mode. An auxiliary power source is turned on to power the PCSs 130 that turn on the EMS 120. After being turned on, the EMS 120 generates instructions to close the switch SW3 and shuts off the switches SW1 and SW2 or maintains the switches SW1 and SW2 in an off state. Optionally, the PV systems charge the battery systems 140 only through the PCSs 130.

Further, the EMS 120 checks whether the household energy storage system 90 satisfies a startup condition. When it is detected the startup condition is satisfied, the EMS 120 sends instructions to turn on the bidirectional battery DC/DC converters, the PV DC/DC converters, and the PV DC/AC inverters at the PCSs 130 for charging the battery systems 140 using DC and AC power from the PV systems (e.g., PV systems 172).

Further, the BMSs 110 detect whether the battery systems 140 are in a charging state. For example, the BMSs 110 may detect whether there is any charging current. In response to detection of charging currents, the BMS 110 may determine a corresponding battery system 140 is in a charging state. If the household energy storage system 90 operates normally and the battery systems 140 are in a charging state, the black start succeeds.

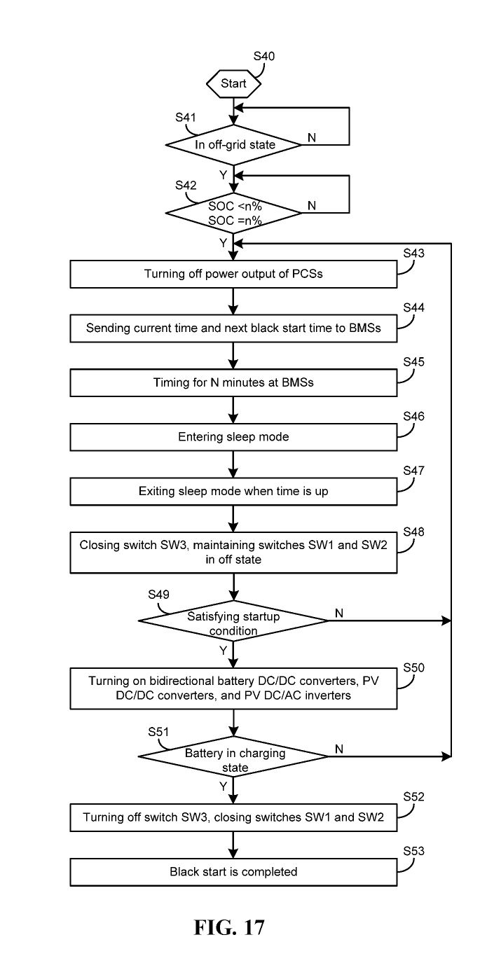

FIG. 17 illustrates a flowchart of a black start method for the household energy storage system 90 in an off-grid state according to embodiments of the present application. The household energy storage system 90 contains one or more energy storage devices. The method shown in FIG. 17 corresponds to the partial structural diagram depicted in FIG. 16. The method starts in step S40. In step S41, after it is detected that the household energy storage system 90 is in an off-grid state, the next step is performed.

In step S42, the household energy storage system 90 detects and determines whether the SOC of all energy storage devices is smaller than or equal to a set value n through the BMSs 110. If the answer is no, step S42 is taken again and the SOC of all energy storage devices is monitored continuously by the BMSs 110. If the answer is yes, i.e., the SOC of all energy storage devices is smaller than or equal to the set value n, the BMSs 110 send a state of the battery systems 140 to the EMS 120 and the next step is performed.

In step S43, the power output of all PCSs is turned off. Further, the power output of all energy storage devices are shut down.

In step S44, the EMS 120 at the household energy storage system 90 sends the current time T1a and next black start time T2a to the BMSs 110. In some cases, step S44 may be performed before step S43.

In step S45, the BMSs 110 starts performing timing for N minutes after receiving the current time T1a and next black start time T2a.

In step S46, after a certain period of time (e.g., starting from time T1a), the main control circuits for monitoring at the household energy storage system 90 are powered off, e.g., by the BMSs 110. The battery systems 140 stop working in step S44 or step S46. The household energy storage system 90 enters a sleep mode.

In step S47, timing is performed at low-power timing control components at the household energy storage system 90. When the time is up, e.g., after performing timing to time T2a, the BMSs 110 or a power supply control system at the household energy storage system 90 is waked up automatically. The household energy storage system 90 exits the sleep mode. Optionally, power is supplied to an auxiliary power source of the PCSs 130, e.g., by the BMSs 110. The auxiliary power source is turned on to power the PCSs 130. Further, the PCSs 130 are turned on to power the EMS 120.

In step S48, the household energy storage system 90 (or the EMS 120) closes the switch SW3 to connect the PCSs 130 with the PV systems and shuts off or keeps shutting off the switches SW1 and SW2, disconnecting the PCSs 130 from the loads and disconnecting the PV systems from the loads.

In step S49, the household energy storage system 90 (or the EMS 120) determines whether a startup condition is satisfied. Exemplary startup conditions may include the household energy storage system 90 has no major failure and the SOC of the battery systems 140 is greater than or equal to a preset value H. If the startup conditions are not satisfied, it goes back to step S43. If the startup conditions are satisfied, it proceeds to the next step.

In step S50, in response to that the startup conditions are met, the household energy storage system 90 generates instructions to turn on the bidirectional battery DC/DC converters, the PV DC/DC converters, and the PV DC/AC inverters for charging the battery systems 140 using DC power and AC power from the PV systems.

In step S51, timing is performed after power is generated from the PV system to charge the battery systems 140. During a period between the N-th minute and the M-th minute, it is detected whether the battery systems 140 are in a charging state. If the battery systems 140 are not in the charging state, it goes back to step S43. If the battery systems 140 are in the charging state at a time in the period, the next step is taken.

In step S52, the household energy storage system 90 (or the EMS 120) turns off the switch SW3 and closes the switches SW1 and SW2. As such, the PCSs 130 become connected with the loads, and the PV systems become connected with the loads too. Before step S52, the loads are disconnected from the PCSs 130 and the PV systems and maintain a power off state.

In step S53, if the battery systems 140 are in the charging state and the household energy storage system 90 operates normally, the EMS 120 determines the black start of the household energy storage system 90 succeeds and is completed.

If it is detected that the battery systems 140 are not in the charging state in step S51 or the household energy storage system 90 does not work normally, the EMS 120 determines the black start fails. The household energy storage system 90 sends a black start failure message to a user and returns to step S42. The household energy storage system 90 repeats operations from step S43 to step S52.

Compared to the method shown in FIG. 15, the above-described method containing steps from S40 to S53 utilizes both the PV DC/DC converters and the PV DC/AC inverters in the black start. As the PV DC/DC converters and the PV DC/AC inverters are turned on together, both DC power and AC power from the PV systems are used to charge the battery systems 140. The charging process is not affected by the loads. The speed of black start may be increased.

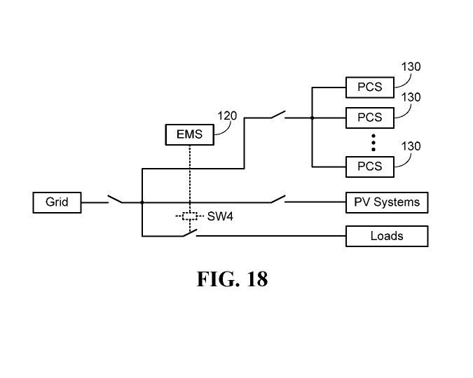

FIG. 18 illustrates a partial structural diagram of the household energy storage system 90 according to embodiments of the present application. The household energy storage system 90 has the configuration as shown in FIG. 14. Optionally, as shown in FIG. 18, the household energy storage system 90 may further include a switch SW4. The switch SW4 is disposed to connect the loads with part of the household energy storage system 90, e.g., electrically connecting the loads to the PCSs 130 and the PV systems, respectively. In some embodiments, the switch SW4 is part of the switch unit 150 shown in FIG. 14. In some other embodiments, the switch SW4 is not part of the switch unit 150 shown in FIG. 14.

As described above, the household energy storage system 90 in an off-grid state may enter a sleep mode. When the time is up, the household energy storage system 90 exits the sleep mode. An auxiliary power source is turned on to power the PCSs 130 that supply power to the EMS 120. The EMS 120 generates instructions to turn on the PCSs 130 and shut off the switch SW4.

When it is at a preset time, the EMS 120 detects whether startup conditions are met, such as whether there is any major failure and whether the SOC of the battery systems 140 is greater than or equal to a set value H. When the startup conditions are satisfied, the EMS turns on the bidirectional battery DC/DC converters, the PV DC/DC converters, and the PV DC/AC inverters for charging the battery systems 140. Optionally, the PV systems may charge the battery systems 140 only through the PCSs 130.

Further, the BMSs 110 detect whether the battery systems 140 are in a charging state. In some cases, the BMSs 110 may detect whether there is any charging current. In response to detection of a charging current, the BMS 110 may determine a corresponding battery system 140 is in a charging state. After it is detected the battery systems 140 are in a charging state, the EMS 120 sends out instructions to close the switch SW4. Further, if the battery systems 140 are in the charging state and the household energy storage system 90 operates normally, the black start succeeds and is completed.

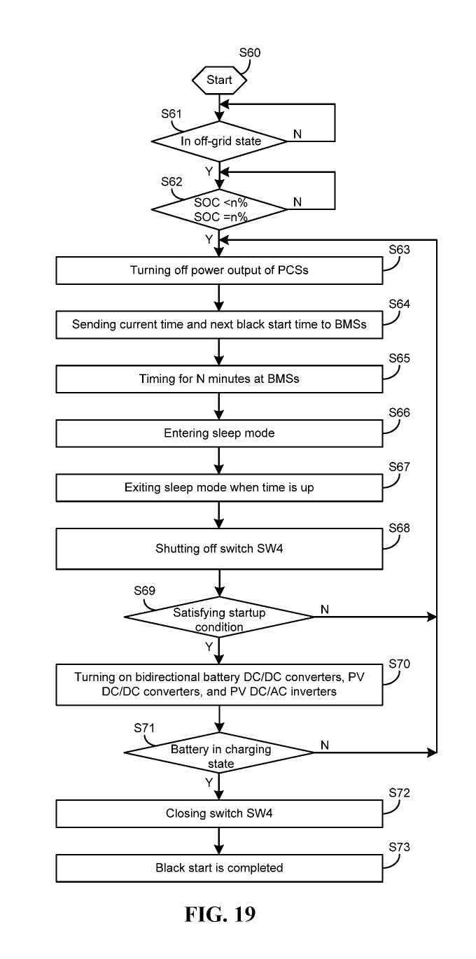

FIG. 19 illustrates a flowchart of a black start method for the household energy storage system 90 in an off-grid state according to embodiments of the present application. The household energy storage system 90 contains one or more energy storage devices. The method shown in FIG. 19 corresponds to the partial structural diagram depicted in FIG. 18. The method starts in step S60. In step S61, after it is detected that the household energy storage system 90 is in an off-grid state, the next step is performed.

In step S62, the household energy storage system 90 detects and determines whether the SOC of all energy storage devices is less than or equal to a set value M1 through the BMSs 110. If the answer is no, step S62 is taken again and the SOC of all energy storage devices is monitored continuously. If the answer is yes, i.e., the SOC of all energy storage devices is less than or equal to the set value M1, the BMSs 110 send a state of the battery systems 140 to the EMS 120 and the next step is performed.

In step S63, the power output of all PCSs is turned off. The power output of all energy storage devices are shut down.

In step S64, the EMS 120 at the household energy storage system 90 sends the current time T1a and next black start time T2a to the BMSs 110.

In step S65, the BMSs 110 starts performing timing for N minutes after receiving the next black start time.

In step S66, after a set period of time from T1a, the main control circuits for monitoring at the household energy storage system 90 are powered off. The battery systems 140 stop working in step S64 or step S66. The household energy storage system 90 enters a sleep mode.

In step S67, timing is performed at low-power timing control components at the household energy storage system 90. When the time is up, e.g., performing timing to time T2a, the BMSs 110 or a power supply control system at the household energy storage system 90 is waked up automatically. The household energy storage system 90 exits the sleep mode. Optionally, power is supplied to an auxiliary power source of the PCSs 130, e.g., by the BMSs 110. The auxiliary power source is turned on to power the PCSs 130. Further, the PCSs 130 are turned on to power the EMS 120.

In step S68, the household energy storage system 90 (or the EMS 120) shuts off the switch SW4. While the PCSs 130 and the PV systems remain connected, the loads are disconnected from the PCSs 130 and the PV systems.

In step S69, the household energy storage system 90 (or the EMS 120) determines whether startup conditions are satisfied. Exemplary startup conditions may include that the household energy storage system 90 has no major failure and the SOC of the battery systems 140 is greater than or equal to a preset value H. If the startup conditions are not satisfied, it goes back to step S63. If the startup conditions are satisfied, it proceeds to the next step.

In step S70, in response to that the startup conditions are met, the household energy storage system 90 generates instructions to turn on the bidirectional battery DC/DC converters, the PV DC/DC converters, and the PV DC/AC inverters for charging the battery systems 140 using DC power and AC power from the PV systems.

In step S71, timing is performed after power is generated from the PV system to charge the battery systems 140. During a period between the N-th minute and the M-th minute, it is detected whether the battery systems 140 are in a charging state. If the battery systems 140 are not in a charging state, it goes back to step S63. If the battery systems 140 are in the charging state at a time of the period, the next step is taken.

In step S72, the household energy storage system 90 (or the EMS 120) closes the switch SW4. As such, the loads become connected with the PCSs 130 and the PV systems, respectively. Before step S72, the loads are disconnected from the PCSs 130 and the PV systems and maintain a power off state.

In step S73, if the battery systems 140 are in the charging state and the household energy storage system 90 operates normally, the EMS 120 determines the black start of the household energy storage system 90 succeeds and is completed.

If it is detected that the battery systems 140 are not in a charging state in step S71 or the household energy storage system 90 does not work normally, the EMS 120 determines the black start fails. The household energy storage system 90 sends a black start failure message to a user and returns to step S62. The household energy storage system 90 repeats operations from step S63 to step S72.

Similar to the method shown in FIG. 17, the above-described method containing steps from S60 to S73 utilizes the PV DC/DC converters and the PV DC/AC inverters in a black start, both AC power and DC power from the PV systems are used to charge the battery systems 140, and the speed of black start may be increased. Further, compared to the configuration shown in FIG. 16, the configuration shown in FIG. 18 has simpler structure, simplified control logic, and simplified control circuits.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A black start method for a household energy storage system in an off-grid state, comprising:
in response to detecting that a battery system is discharged to a state of charge (SOC) of less than or equal to a set value M, sending, by a battery management system (BMS), a state of the battery system to an energy management system (EMS), wherein M is a number greater than 0 and less than 1;
sending, by the EMS, timing starting time T1 and black start time T2 to the BMS;
starting, by the BMS, timing from T1 and after a time T, causing the household energy storage system to enter a sleep mode;
in response to performing timing to T2, exiting the sleep mode and turning on, by the BMS, an auxiliary power supply for power supply to the EMS; and
in response to detecting that a startup condition is satisfied, turning on a bidirectional battery DC/DC converter and a photovoltaic (PV) DC/DC converter connected to the BMS and a PV system, respectively, for charging the battery system using power from the PV system.

2. The black start method of claim 1, further comprising:
in response to detecting that the battery system is in a charging state, determining, by the EMS, that a black start of the household energy storage system succeeds.

3. The black start method of claim 1, further comprising:
after detecting that the battery system is in a charging state, turning on a bidirectional DC/AC inverter connected to the BMS for charging the battery system.

4. The black start method of claim 3, wherein the household energy storage system further comprises a power conversion system (PCS) including the bidirectional battery DC/DC converter, the PV DC/DC converter, the bidirectional DC/AC inverter, and the auxiliary power supply, and connected with the EMS, the BMS, the battery system, and the PV system, respectively.

5. The black start method of claim 4, further comprising:
before causing the household energy storage system to enter the sleep mode, turning off output power of the PCS.

6. The black start method of claim 1, wherein the startup condition includes the SOC of the battery system is greater than or equal to a predetermined value.

7. The black start method of claim 1, wherein before detecting that the battery system is in the charging state, a load maintains a power off state.

8. A black start method for a household energy storage system in an off-grid state, comprising:
in response to detecting that a battery system is discharged to a state of charge (SOC) of less than or equal to a set value M, sending, by a battery management system (BMS), a state of the battery system to an energy management system (EMS), wherein M is a number greater than 0 and less than 1, and the BMS and the battery system are connected to a power conversion system (PCS), respectively;
sending, by the EMS, timing starting time T1 and black start time T2 to the BMS;
starting, by the BMS, timing from T1 and after a time T, causing the household energy storage system to enter a sleep mode;
in response to performing timing to T2, exiting the sleep mode and turning on, by the BMS, an auxiliary power supply for power supply to the EMS; and
in response to detecting that a startup condition is satisfied, shutting off a first switch and a second switch to disconnect the PCS from a load and disconnect a photovoltaic (PV) system from the load, and closing a third switch to connect the PCS with the PV system.

9. The black start method of claim 8, further comprising:
in response to detecting that the battery system is in a charging state, determining, by the EMS, that a black start of the household energy storage system succeeds.

10. The black start method of claim 8, further comprising:
in response to detecting that the startup condition is satisfied, turning on a bidirectional battery DC/DC converter, a PV DC/DC converter, and a bidirectional DC/AC inverter included in the PCS and connected to the BMS and the PV system, respectively, for charging the battery system using power from the PV system.

11. The black start method of claim 8, further comprising:
before causing the household energy storage system to enter the sleep mode, turning off output power of the PCS.

12. The black start method of claim 8, wherein the startup condition includes the SOC of the battery system is greater than or equal to a predetermined value.

13. The black start method of claim 8, further comprising:
after detecting that the battery system is in a charging state, shutting off the third switch, and closing the first switch and the second switch to connect the PCS with the load and connect the PV system with the load.

14. The black start method of claim 9, wherein before detecting that the battery system is in the charging state, the load maintains a power off state.

15. A black start method for a household energy storage system in an off-grid state, comprising:
in response to detecting that a battery system is discharged to a state of charge (SOC) of less than or equal to a set value M, sending, by a battery management system (BMS), a state of the battery system to an energy management system (EMS), wherein M is a number greater than 0 and less than 1, the BMS and the battery system are connected to a power conversion system (PCS), respectively, and the PCS is connected to a photovoltaic (PV) system;
sending, by the EMS, timing starting time T1 and black start time T2 to the BMS;
starting, by the BMS, timing from T1 and after a time T, causing the household energy storage system to enter a sleep mode;
in response to performing timing to T2, exiting the sleep mode and turning on, by the BMS, an auxiliary power supply for power supply to the EMS; and
in response to detecting that a startup condition is satisfied, shutting off a switch to disconnect the PCS from a load and disconnect the PV system from the load.

16. The black start method of claim 15, further comprising:
in response to detecting that the battery system is in a charging state, determining, by the EMS, that a black start of the household energy storage system succeeds.

17. The black start method of claim 15, further comprising:
in response to detecting that the startup condition is satisfied, turning on a bidirectional battery DC/DC converter, a PV DC/DC converter, and a bidirectional DC/AC inverter included in the PCS and connected to the BMS and the PV system, respectively, for charging the battery system using power from the PV system.

18. The black start method of claim 15, wherein the startup condition includes the SOC of the battery system is greater than or equal to a predetermined value.

19. The black start method of claim 15, further comprising:
before causing the household energy storage system to enter the sleep mode, turning off output power of the PCS.

20. The black start method of claim 15, further comprising:
after detecting that the battery system is in a charging state, closing the switch to connect the PCS with the load and connect the PV system with the load.
